(19) United States
(12) Patent Application Publication
(10) Pub. No.: US 2005/0007544 A1
(43) Pub. Date: Jan. 13, 2005

(54) Interconnecting assembly in combination with primary and auxiliary eyeglasses

(76) Inventor: Ming Che Wu, Chiayi (TW)

Correspondence Address: GREENBERG TRAURIG LLP, 885 THIRD AVENUE, 21ST FLOOR, NEW YORK, NY, 10022, US

(21) Appl. No.: 10/618,132

(22) Filed: Jul. 11, 2003

(51) Int. Cl. G02C 7/08

(52) U.S. Cl. 351/57

(57) ABSTRACT

One embodiment of the present invention relates to an eyeglass assembly including a pair of first eyeglasses having a first bridge interconnecting a pair of first lenses and a pair of second eyeglasses having a second bridge interconnecting a pair of second lenses. At least one rib may be formed on a rear portion of the second bridge. A retainer may be integrally formed with the first bridge and may include an upper clamping plate and a lower clamping plate. The lower clamping plate may have at least one restricting groove to correspond to the at least one rib so that combination of the at least rib and the at least one restricting groove is able to combine the first eyeglasses and the second eyeglasses.

### BACKGROUND OF THE INVENTION

1. Field of the Invention

One embodiment of the present invention relates to an interconnecting assembly in combination with primary and auxiliary eyeglasses. More particularly, the auxiliary eyeglasses may be detachably connected to the primary eyeglasses.

2. Description of Related Art

U.S. Pat. No. 6,264,323, which issued to Chao on Jul. 24, 2001, relates to an assembly of primary and auxiliary eyeglasses which are interconnected by a retainer clip.

U.S. Pat. No. 6,341,864, which issued to Ng on Jan. 29, 2002, relates to clip-on auxiliary lenses utilizing an elastic jaw in the shape of a half arch.

U.S. Pat. No. 6,375,322, which issued to Takagi on Apr. 23, 2002, relates to front hook eyeglasses and method of attaching front hook eyeglasses onto eyeglasses body.

### BRIEF DESCRIPTION OF THE DRAWINGS

FIG. 1 is an exploded perspective view of the interconnecting assembly of an embodiment of the present invention in combination with primary and auxiliary eyeglasses;

FIG. 2 is a schematic view showing how the interconnecting assembly of an embodiment of the present invention is connecting the auxiliary eyeglasses to the primary eyeglasses;

FIG. 3 is a schematic view showing the initial stage of the movement of the insert into the clamping plates according to an embodiment of the present invention;

FIG. 4 is a schematic view showing that the insert is positioned in the clamping plates by the combination of rib and groove according to an embodiment of the present invention;

FIG. 5 is a schematic view showing one embodiment of the interconnecting assembly of the present invention;

FIG. 6 is a schematic view showing another embodiment of the interconnecting assembly of the present invention;

FIG. 7 is a schematic view showing another embodiment of the interconnecting assembly of the present invention;

FIG. 8 is an exploded perspective view of another embodiment of the present invention; and

FIG. 9 is a schematic view showing the assembly of the primary and auxiliary eyeglasses shown in FIG. 8.

### DETAILED DESCRIPTION OF THE INVENTION

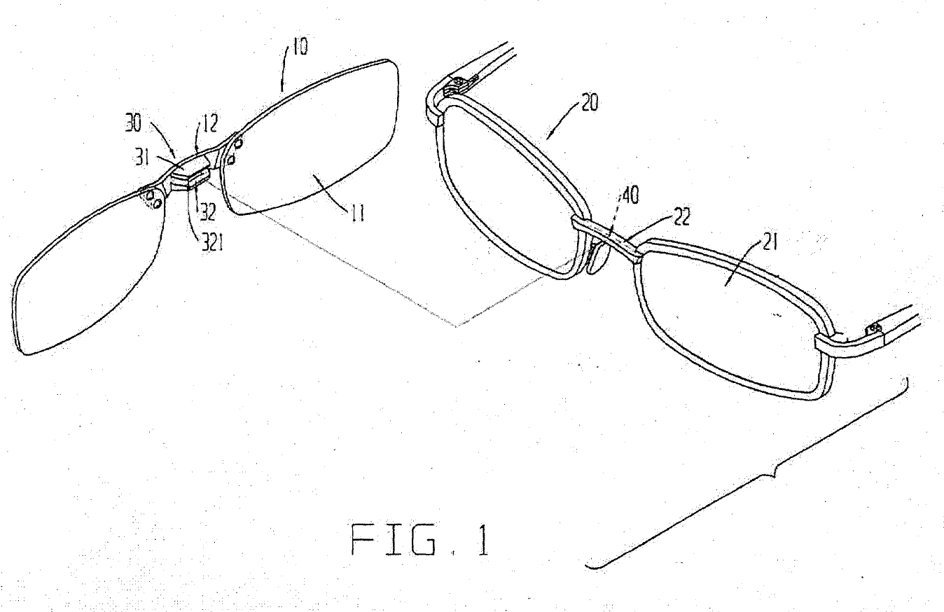

Referring now to FIG. 1, an embodiment of an eyeglasses assembly of the present invention is shown. As seen in this FIG. 1, the eyeglasses assembly has a first pair of eyeglasses (10) and a second pair of eyeglasses (20).

The first eyeglasses (10) has two first lenses (11) and a first bridge (12) interconnecting the two first lenses (11) together. The first bridge (12) has a retainer (30) formed on the first bridge (12) . The retainer (30) has an upper clamping plate and a lower clamping plate (31,32). The lower clamping plate (32) has a restricting groove (321) defined in a front portion of the lower clamping plate (32).

The second eyeglasses (20) has two second lenses (21) and a second bridge (22) interconnecting the pair of second lenses (21). The second bridge (22) has a rib (40) formed on a rear portion of the second bridge (22) to correspond to the restricting groove (321).

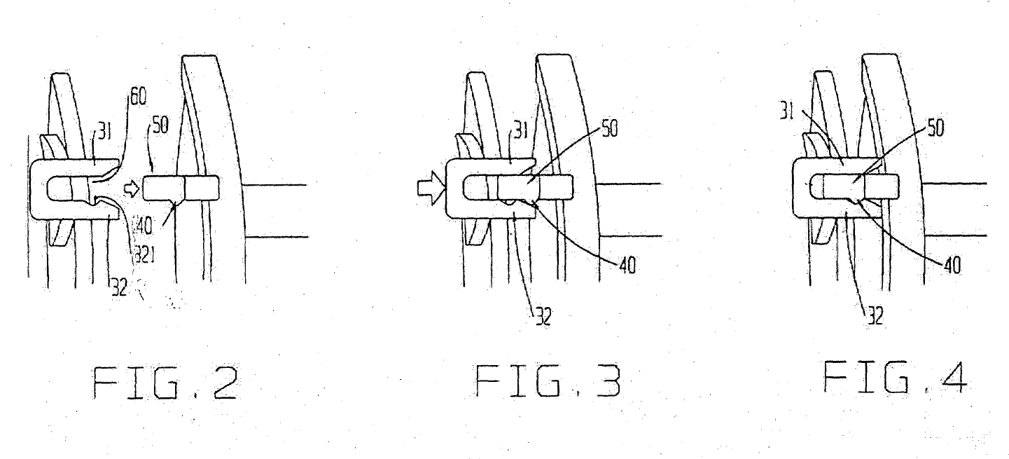

With reference now to both FIGS. 1 and 2, it is to be noted that the interconnecting assembly of this embodiment of the present invention comprises: (a) the retainer (30) that is integrally formed on the first bridge (12); and (b) the rib (40) that is integrally formed on the second bridge (22). A portion of the second bridge (22) with the rib (40) is hereinafter referred to as an insert (50) as shown in FIG. 2, for example.

It is noted that the upper clamping plate (31) has an inclined inner face formed on a free end of the upper clamping plate (31) and the lower clamping plate (32) also has an inclined inner face formed on a free end of the lower clamping plate (32), thereby forming an enlarged space (60) defined between the upper clamping plate (31) and the lower clamping plate (32). The restricting groove (321) is thus defined adjacent the inclined inner face of the lower clamping plate (32).

With reference to FIGS. 2, 3 and 4, it is noted that both side faces (i.e., the faces adjacent upper claming plate (31) and lower clamping plate (32)) of the front portion of the insert (50) are flat when the insert (50) initially extends into the enlarged space (60). Thus, neither the upper clamping plate (31) nor the lower clamping plate (32) are forced to move away from each other (instead, the upper clamping plate (31) and the lower clamping plate (32) remain essentially at their original positions). Further, when the rib (40) enters the enlarged space (60) between the upper clamping plate (31) and the lower clamping plate (32) the rib (40) also will not force the upper clamping plate (31) or the lower clamping plate (32) to move away from each other (instead, the upper clamping plate (31) and the lower clamping plate (32) remain essentially at their original positions). This is due to the dimension of the enlarged space (60) being larger than a dimension of the insert (50) together with the rib (40). Only when the rib (40) passes the joint between the inclined inner face of the lower clamping plate (32) and the restricting groove (321), a slight bending (e.g, of the lower clamping plate (32)) occurs to allow the insert(50) (including the rib (40)) to pass over the joint between the inclined inner face of the lower clamping plate (32) and the restricting groove (321). Further, when the rib (40) is fittingly (and removeably) received in the restricting groove (321), the first eyeglasses (10) is secured to the second eyeglasses (20).

With reference now to FIG. 5, another embodiment of the present invention is shown. As seen in this FIG. 5, the retainer (30) is integrally formed with the restricting groove (321). The insert (50) of the second eyeglasses (20) has two truncated corners (51) oppositely formed on top and bottom faces of the insert (50) (i.e., the faces adjacent upper claming plate (31) and lower clamping plate (32)) to correspond to the space between the upper and lower clamping plates (31,32). Therefore, the movement of the insert (50) into the retainer (30) is easily accomplished.

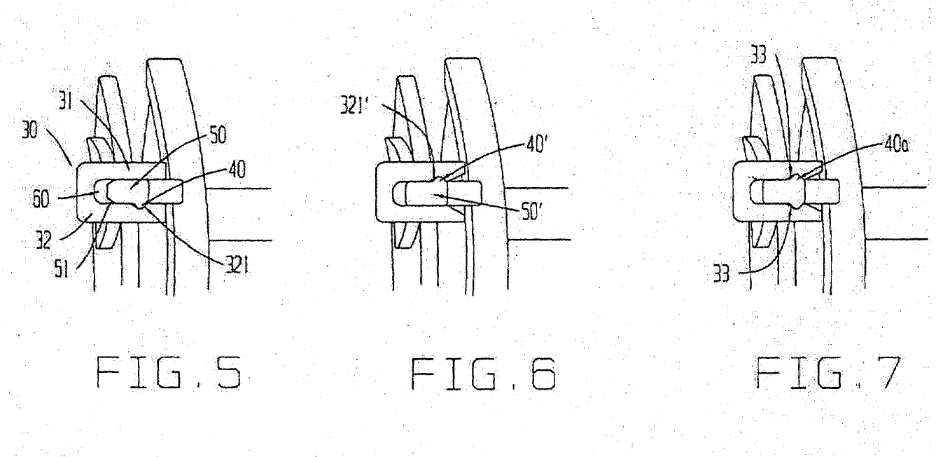

With reference now to FIG. 6, another embodiment of the present invention is shown. As seen in this FIG. 6, the upper clamping plate (31′) of retainer (30′) has an inclined face on the inner face of the upper clamping plate (31′) and the lower clamping plate (32′) of retainer (30′) has an inclined face on the inner face of the lower clamping plate (32′) to correspond to the inclined face of the upper clamping plate (31′). Accordingly, the enlarged space (60′) is defined between the upper and lower clamping plates (31′,32′). Furthermore, a restricting groove (321′) is defined in the front portion of the inner face of the upper clamping plate (31′) and the rib (40′) is formed on a rear portion of a top face of the insert (50′) to correspond to the restricting groove (321′). With the enlarged space (60′) defined between the upper clamping plate (31′) and the lower clamping plate (32′), the movement of the insert (50′) into the retainer (30′) is easily accomplished.

With reference now to FIG. 7, a further embodiment of the interconnecting assembly of the present invention shows that the retainer (30″) has two restricting grooves (33) respectively defined in the inner faces of the upper clamping plate (31″) and the lower clamping plate (32″). The insert (50″) has two ribs (40a) respectively formed on opposite faces of the insert (50″) to correspond to the restricting grooves (33). Therefore, the ribs (40a) are able to be fittingly (and removeably) received in the corresponding restricting grooves (33).

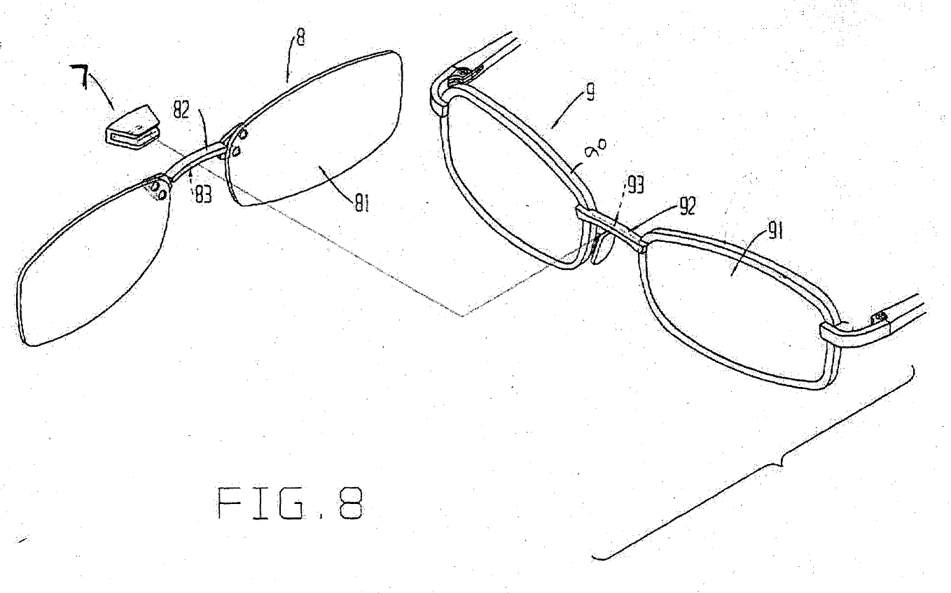

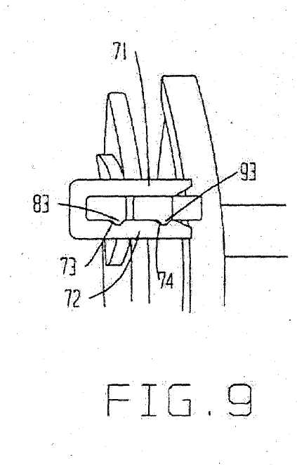

With reference now to FIGS. 8 and 9, a still further embodiment of the present invention shows that the interconnecting assembly includes a retainer 7. The retainer (7) includes an upper clamping plate (71) and a lower clamping plate (72) provided with first and second restricting grooves (73,74). A pair of first eyeglasses (8) has two first lenses (81) and a first bridge (82) interconnecting the first lenses (81). The first bridge (82) has a first rib (83) formed on a bottom face of the first bridge (82). A pair of second eyeglasses (9) has two second lenses (91) and a second bridge (92) interconnecting the two second lenses (91). The second bridge (92) has a second rib (93) formed on a bottom face of the second bridge (92).

When the retainer (7) is used to interconnect the first eyeglasses (8) and the second eyeglasses (9), the first bridge (82) extends into the retainer (7) to have the first rib (83) received in the first restricting groove (73), then the second bridge (92) extends into the retainer (7) to have the second rib (93) received in the second restricting groove (74). Thus, the first eyeglasses (8) and the second eyeglasses (9) are secured by the retainer (7).

It is noted that when the first eyeglasses and the second eyeglasses are connected by the retainer, due to the enlarged space between the upper clamping plate and the lower clamping plate and/or the truncated corners on the insert, the movement of the insert into the retainer is easy and smooth.

Furthermore, at the initial stage of the movement of the insert into the retainer, essentially no bending of the upper clamping plate and the lower clamping plate occurs, which bending could tend to break the connection between the upper clamping plate and the lower clamping plate (thus, the life span of the retainer may be maximized).

In another embodiment of the present invention an interconnecting assembly in combination with primary and auxiliary eyeglasses is provided (wherein the combination of the primary eyeglasses and the auxiliary eyeglasses is easily accomplished and does essentially no damage to the clamping plates).

In another embodiment of the present invention the clamping plates define an enlarged receiving opening between the clamping plates, so that the movement of the insert into the space between the clamping plates is easily accomplished.

In another embodiment of the present invention the insert may have one or two truncated corners (wherein the truncated corners may correspond to the space between the clamping plates so that the movement of the insert into the space between the clamping plates is easily accomplished).

In another embodiment of the present invention the insertion of a bridge into a retainer generates essentially no bending force to either an upper clamping plate or a lower clamping plate during an initial stage of a combination between a first pair of eyeglasses and a second pair of eyeglasses until the rib associated with the bridge is inserted into the retainer (because, in this embodiment, the rib is formed on a rear portion of the bridge and the restricting groove of the retainer is defined in a front portion of an inner face of the lower clamping plate.

In another embodiment of the present invention the insertion of a first bridge and a second bridge generates essentially no bending force to either an upper clamping plate or a lower clamping plate during an initial stage of a combination between a first pair of eyeglasses and a second pair of eyeglasses until at least one of the ribs associated with the first and second bridges is inserted into the retainer (because, in this embodiment, the first and second ribs are formed respectively on a rear portion of the first and second bridges and the two restricting grooves are defined in the front portion of the inner face of the lower clamping plate).

While a number of embodiments of the present invention have been described, it is understood that these embodiments are illustrative only, and not restrictive, and that many modifications may become apparent to those of ordinary skill in the art. For example, the various mounting elements (e.g., ribs, grooves, etc.) may be mounted on any desired combination of surfaces (e.g., any combination of upper and/or lower surfaces). Further, any desired number of corresponding mounting elements may be utilized.

1. An eyeglass assembly, comprising:
a pair of first eyeglasses having a pair of first lenses and a first bridge interconnecting the pair of first lenses;
a pair of second eyeglasses having a pair of second lenses and a second bridge interconnecting the pair of second lenses and provided with at least one rib formed on a rear portion of the second bridge; and
a retainer integrally formed with the first bridge and consisting of an upper clamping plate, a lower clamping plate and a space defined between the upper clamping plate and the lower clamping plate, wherein at least one of the upper clamping plate and the lower clamping plate has at least one restricting groove defined in a front portion of an inner face thereof to correspond to the at least one rib so that combination of the at least one rib and the at least one restricting groove is able to combine the first pair of eyeglasses and the second pair of eyeglasses;
wherein the upper clamping plate has a first inclined face formed on an inner face of the upper clamping plate and the lower clamping plate has a second inclined face formed on an inner face of the lower clamping plate to correspond to the inclined face of the upper clamping plate, thereby defining an enlarged space communicating with the space defined between the upper clamping plate and the lower clamping plate;
wherein the second bridge has two truncated corners respectively formed on opposite top and bottom faces of the second bridge to correspond to the space defined between the upper clamping plate and the lower clamping plate; and
wherein the second bridge is sufficiently wide such that at least a forward portion of the second bridge enters the space defined between the upper clamping plate and the lower clamping plate when the at least one rib on the rear portion of the second bridge is received in the at least one restricting groove,
whereby insertion of the second bridge into the retainer generates essentially no bending force to either the upper clamping plate or the lower clamping plate until the at least one rib is inserted into the retainer; and
whereby the second bridge is held in a substantially non-pivoting relationship to the first bridge due at least in part to the second bridge being sufficiently wide such that at least a forward portion of the second bridge enters the space defined between the upper clamping plate and the lower clamping plate when the at least one rib on the rear portion of the second bridge is received in the at least one restricting groove.

2. Cancelled

3. Cancelled

4. The eyeglass assembly as claimed in claim 1, wherein there are two ribs respectively and oppositely formed on the second bridge and there are two restricting grooves respectively and oppositely formed on an inner face of the retainer to correspond to the two ribs.

5. The eyeglass assembly as claimed in claim 1, wherein: (a) the second bridge has a bottom face and the at least one rib is formed on the bottom face of the second bridge; and (b) the lower clamping plate of the retainer has a top face and the at least one restricting groove is defined in the top face of the lower clamping plate.

6. The eyeglass assembly as claimed in claim 1, wherein: (a) the second bridge has a top face and the at least one rib is formed on the top face of the second bridge; and (b) the upper clamping plate of the retainer has a bottom face and the at least one restricting groove is defined in the bottom face of the upper clamping plate.

7. The eyeglass assembly as claimed in claim 4, wherein: (a) the second bridge has a top face and a bottom face and the two ribs are respectively and oppositely formed on the top face of the second bridge and the bottom face of the second bridge; and (b) the upper clamping plate has an inner bottom face and the lower clamping plate has an inner top face, the two restricting grooves being respectively formed on the inner bottom face of the upper clamping plate and the inner top face of the lower clamping plate to correspond to the two ribs.

8. An eyeglass assembly, comprising:
a pair of first eyeglasses having a pair of first lenses and a first bridge interconnecting the pair of first lenses, which first bridge is provided with a first rib formed on a rear portion of the first bridge;
a pair of second eyeglasses having a pair of second lenses and a second bridge interconnecting the pair of second lenses, which second bridge is provided with a second rib formed on a rear portion of the second bridge; and
a retainer detachably connected to the first bridge and the second bridge, the retainer comprising an upper clamping plate, a lower clamping plate and a space defined between the upper clamping plate and the lower clamping plate, wherein at least one of the upper clamping plate and the lower clamping plate has two restricting grooves defined in a front portion of an inner face thereof to correspond to the first rib and the second rib so that combination of the first rib and the second rib and the two restricting grooves is able to combine the first eyeglasses and the second eyeglasses;
wherein the upper clamping plate has a first inclined face formed on an inner face of the upper clamping plate and the lower clamping plate has a second inclined face formed on an inner face of the lower clamping plate to correspond to the inclined face of the upper clamping plate, thereby defining an enlarged space communicating with the space defined between the upper clamping plate and the lower clamping plate;
wherein the second bridge has two truncated corners respectively formed on opposite top and bottom faces of the second bridge to correspond to the space defined between the upper clamping plate and the lower clamping plate: and
wherein the second bridge is sufficiently wide such that at least a forward portion of the second bridge enters the space defined between the upper clamping plate and the lower clamping plate when the first rib and the second rib on the rear portion of the first bridge and the second bridge are received in respective restricting grooves;
whereby insertion of the first bridge and second bridge into the retainer generates essentially no bending force to either the upper clamping plate or the lower clamping plate until at least one of the ribs is inserted into the retainer; and
whereby the second bridge is held in a substantially non-pivoting relationship to the first bridge due at least in part to the second bridge being sufficiently wide such that at least a forward portion of the second bridge enters the space defined between the upper clamping plate and the lower clamping plate when the rib on the rear portion of the second bridge is received in a respective restricting groove.

9. Cancelled

10. Cancelled

11. The eyeglass assembly as claimed in claim 8, wherein the first bridge has two truncated corners respectively formed on opposite top and bottom faces of the first bridge to correspond to the space defined between the upper clamping plate and the lower clamping plate.
